(19) United States
(12) Patent Application Publication
(10) Pub. No.: US 2026/0074964 A1
(43) Pub. Date: Mar. 12, 2026

(54) INFORMATION TRANSMISSION METHOD AND APPARATUS

(71) Applicant: FUJITSU LIMITED, Kawasaki-shi (JP)

(72) Inventor: Xin WANG, Beijing (CN)

(73) Assignee: FUJITSU LIMITED, Kawasaki-shi (JP)

(21) Appl. No.: 19/386,739

(22) Filed: Nov. 12, 2025

Related U.S. Application Data
(63) Continuation of application No. PCT/CN2023/094146, filed on May 15, 2023.

(51) Int. Cl. H04L 41/16; H04B 7/06

(52) U.S. Cl. CPC H04L 41/16; H04B 7/0626

(57) ABSTRACT

An information transmission apparatus, configured in a terminal equipment, includes: a transmitter configured to transmit indication information on an AI/ML feature and/or functionality to a network device.

### CROSS-REFERENCE TO RELATED APPLICATION

This application is a continuation application under 35 U.S.C. 111(a) of International Patent Application PCT/CN2023/094146 filed on May 15, 2023, and designated the U.S., the entire contents of which are incorporated herein by reference.

### TECHNICAL FIELD

This disclosure relates to the field of communication technologies.

### BACKGROUND

As low-frequency spectrum resources become scarce, the millimeter wave band can provide greater bandwidth and has become an important frequency band for 5G New Radio (NR) systems. Millimeter waves have different propagation characteristics from traditional low-frequency bands due to their shorter wavelength, such as higher propagation loss, poor reflection and diffraction performance, etc. Therefore, larger antenna arrays are usually used to form shaped beams with greater gain, overcome propagation losses, and ensure system coverage.

With the development of artificial intelligence (AI) and machine learning (ML) technologies, applying AI/ML technology to wireless communication to solve the difficulties of traditional methods has become a current technological direction. The application of AI/ML models in wireless communication systems, especially in air interface transmission, is a new technology in the 5G Advanced and 6G stages.

For example, for reporting Channel State Information (CSI), using Autoencoder network in deep learning on the terminal device side to encode/compress CSI with AI encoder, and decoding/decompressing CSI with AI decoder on the network device side can reduce feedback overhead. For example, in beam management, using AI/ML models to predict the spatially optimal beam pair based on a small number of beam measurements can reduce system load and latency.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In 5G and 6G systems, a wide range of terminal technology features (UE features) are defined. Not all features are necessarily supported by a terminal. A network learns support of the UE features through query and reporting of a terminal equipment capability, i.e. UE capability, so that the network may have an understanding of the UE capability, thereby providing a foundation for its subsequent scheduling, configuration and communication of the terminal.

According to the current trends in 5G-advanced and 6G technologies, a terminal equipment may possibly support multiple AI/ML features. A feature can be more specifically described by functional parameters of a predefined feature group. Features in each feature group can be regarded as a sub-feature, or may be referred to as a functionality. Another possibility is to activate or enable a functionality at the terminal side by transmitting configurations pre-defined features and feature groups by the network side to the terminal equipment. For an AI/ML feature or AI/ML functionality enabled or activated by the network side, the network side monitors performances of the AI/ML feature or functionality.

However, it was found by the inventor that a response of the network side to monitoring the performances of the AI/ML feature or functionality is relatively slow or inaccurate, resulting in an inability to fully utilize the AI/ML functionality to improve communication quality.

In order to solve at least one of the above problems, embodiments of this disclosure provide an information transmission method and apparatus.

According to a first aspect of the embodiments of this disclosure, there is provided an information transmission method, including: transmitting, by a terminal equipment, indication information on an AI/ML feature and/or functionality to a network device.

According to a second aspect of the embodiments of this disclosure, there is provided an information transmission method, including: receiving, by a network device, indication information on an AI/ML feature and/or functionality transmitted by a terminal equipment.

According to a third aspect of the embodiments of this disclosure, there is provided an information transmission apparatus, configured in a terminal equipment, the apparatus including: a first transmitting unit configured to transmit indication information on an AI/ML feature and/or functionality to a network device.

According to a fourth aspect of the embodiments of this disclosure, there is provided an information transmission apparatus, configured in a network device, the apparatus including: a second receiving unit configured to receive indication information on an AI/ML feature and/or functionality transmitted by a terminal equipment.

According to a fifth aspect of the embodiments of this disclosure, there is provided a computer readable program, which, when executed in an information transmission apparatus or a terminal equipment, will cause the information transmission apparatus or the terminal equipment to carry out the information transmission method as described in the first aspect of the embodiments of this disclosure.

According to a sixth aspect of the embodiments of this disclosure, there is provided a computer readable program, which, when executed in an information transmission apparatus or a network device, will cause the information transmission apparatus or the network device to carry out the information transmission method as described in the second aspect of the embodiments of this disclosure.

According to a seventh aspect of the embodiments of this disclosure, there is provided a computer readable medium, including a computer readable program, which will cause an information transmission apparatus or a terminal equipment to carry out the information transmission method as described in the first aspect of the embodiments of this disclosure.

According to an eighth aspect of the embodiments of this disclosure, there is provided a computer readable medium, including a computer readable program, which will cause an information transmission apparatus or a network device to carry out the information transfer method as described in the second aspect of the embodiments of this disclosure.

An advantage of the embodiments of this disclosure exists in that the terminal equipment transmits the indication information on an AI/ML feature and/or functionality to the network device, hence, the network device may timely and accurately learn an actual situation of performances of the AI/ML feature and/or functionality, and achieves accurate operations of the AI/ML feature and/or functionality, thereby fully utilizing the AI/ML functionality to improve communication quality, and improving performances of the communication system.

Another advantage of the embodiments of this disclosure exists in that the implementation of the AI/ML model of the terminal equipment is invisible to the network device, and the terminal equipment may observe and monitor the model at the terminal side in a timely and accurate manner. The result of the monitoring may more accurately and timely reflect performances of functional levels. The terminal equipment transmits indication or request information regarding changes in the model at the terminal side or its performance evaluation of the functional levels to the network device, which is helpful to the operations of the functionality by the network device. Compared with a solution where the terminal equipment is not used to transmit the information, the AI/ML functionality may be timely and reliably used to improve communication quality, and improve performances of the communication system.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of exchange between a network device and a terminal equipment;

FIG. 3 is a schematic diagram of an equipment having an AI/ML functional module;

FIG. 4 is another schematic diagram of exchange between the network device and the terminal equipment;

FIG. 5 is a schematic diagram of an information transmission method of an embodiment of this disclosure;

FIG. 6 is a modular schematic diagram of the network device and the terminal equipment;

FIG. 7 is a schematic diagram of exchange between the network device and the terminal equipment in application scenario 1 in the embodiments of this disclosure;

FIGS. 8A and 8B are schematic diagrams of comparison between an exchange process in the method of the embodiments of this disclosure and an exchange process in an existing method;

FIG. 9 is a schematic diagram of exchange between the network device and the terminal equipment in application scenario 2 in the embodiments of this disclosure;

FIG. 10 is a schematic diagram of exchange between the network device and the terminal equipment in application scenario 3 in the embodiments of this disclosure;

FIG. 11 is a schematic diagram of exchange between the network device and the terminal equipment in application scenario 4 in the embodiments of this disclosure;

FIG. 12 is a schematic diagram of exchange between the network device and the terminal equipment in application scenario 5 in the embodiments of this disclosure;

FIG. 13 is another schematic diagram of the information transmission method of the embodiments of this disclosure;

FIG. 14 is a schematic diagram of a method for verifying performances of a model of an embodiment of this disclosure;

FIG. 15 is another schematic diagram of the method for verifying performances of a model of the embodiments of this disclosure;

FIG. 16 is a further schematic diagram of the method for verifying performances of a model of the embodiments of this disclosure;

FIG. 17 is a schematic diagram of a method for identifying an AI/ML model of an embodiment of this disclosure;

FIG. 18 is another schematic diagram of the method for identifying an AI/ML model of the embodiments of this disclosure;

FIG. 19 is a further schematic diagram of the method for identifying an AI/ML model of the embodiments of this disclosure;

FIG. 20 is a schematic diagram of an information transmission apparatus of an embodiment of this disclosure;

FIG. 21 is another schematic diagram of the information transmission apparatus of the embodiments of this disclosure;

FIG. 22 is a schematic diagram of a systematic structure of a terminal equipment of an embodiment of this disclosure; and

FIG. 23 is a schematic diagram of a systematic structure of a network device of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. For example, a 5G base station gNB may include a gNB CU and one or more gNB DUs, wherein the CU/DU is a logical node of the gNB having a part of functions of the gNB. And a term “cell” may refer to a base station and/or its coverage area, depending on a context of the term. One gNB-DU supports one or more cells, and one cell is supported by only one gNB-DU.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc., such as a terminal equipment served by an IAB-node or an IAB-donor under an IAB architecture.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment.

Scenarios of the embodiments of this disclosure shall be described below by way of examples; however, this disclosure is not limited thereto.

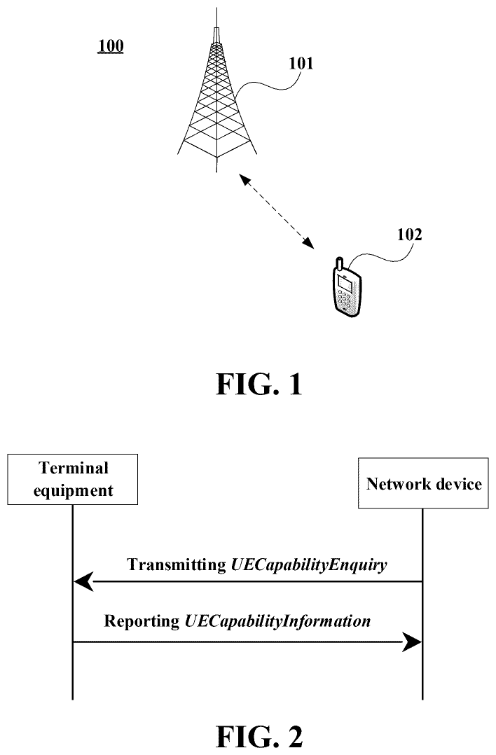

FIG. 1 is a schematic diagram of a communication system of this disclosure, in which a case where a terminal equipment and a network device are taken as examples is schematically shown. As shown in FIG. 1, the communication system 100 may include a network device 101 and a terminal equipment 102. For the sake of simplicity, an example having only one terminal equipment and one network device is schematically given in FIG. 1; however, the embodiments of this disclosure is not limited thereto.

In the embodiments of this disclosure, existing services or services that may be implemented in the future may be performed between the network device 101 and the terminal equipment 102. For example, such services may include but not limited to an enhanced mobile broadband (eMBB), massive machine type communication (MTC), and ultra-reliable and low-latency communication (URLLC), etc.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

In the embodiments of this disclosure, the network device learns support of UE features through query and reporting of a terminal equipment capability (UE capability), so that the network may have an understanding of the UE capability, thereby providing a foundation for its subsequent scheduling, configuration and communication of the terminal.

FIG. 2 is a schematic diagram of exchange between the network device and the terminal equipment. As shown in FIG. 2, the network device transmits a UE capability enquiry request, such as UECapabilityEnquiry, to the terminal equipment (UE), and the terminal equipment reports its UE capability information, such as UECapabilityInformation, to the network device.

For an equipment having AI/ML functional modules, such as the terminal equipment, this functionality may possibly not be a functionality that the terminal equipment must support. According to a current technical trend in 5G-Advanced and 6G, a terminal equipment may possibly support multiple AI/ML features. A feature may be described more specifically by functional parameters of a predefined feature group.

In the embodiments of this disclosure, for a certain use case or communication functionality, such as CSI feedback, CSI prediction, beam management, beam prediction, positioning, and mobility management, etc., it may be classified as a feature, such as a CSI feedback AI/ML feature, a CSI prediction AI/ML feature, a beam management AI/ML feature, and a positioning AI/ML feature, etc.

In the embodiments of this disclosure, each feature may be further subdivided into feature groups, and features in each group may be regarded as a sub-feature, or may be referred to as a functionality.

For example, an AI/ML feature or a feature group includes one or more AI/ML functionalities.

The AI/ML functionality of the terminal equipment may also be reported by the network device according to the capability of the terminal equipment, and is configured to the terminal equipment based on a capability and judgment of the network device, thereby configuring one or more capabilities of the terminal equipment, or activating one or more capabilities of the terminal equipment.

The AI/ML functionality of the terminal equipment may also be reported by the network device according to the functionality of the terminal equipment, and is configured to the terminal equipment based on a capability and judgment of the network device, thereby configuring one or more capabilities of the terminal equipment, or activating one or more capabilities of the terminal equipment. The reporting of the functionality of terminal equipment described here is different from a capability reporting process of the terminal equipment, and corresponds to short-term, temporary, or current AI/ML function information reported by the terminal equipment to the base station according to support of functional features or functionalities in the short-term, temporary, or current situation.

In the embodiments of this disclosure, a functionality may also be referred to as a sub-feature, and different sub-features are distinguished by corresponding parameters or applicable conditions. Different sub-features or functionalities may have identifiers (IDs) or pre-defined corresponding indices.

Hence, different features may be distinguished by different feature identifiers, and different sub-features or functions under a feature may be distinguished by different sub-feature IDs or functionality IDs, or, different functionalities may be reported by the network device according to the capability of the terminal equipment and configured to the terminal equipment.

As described above, an AI/ML feature or feature group includes one or more AI/ML functionalities. For example, for a CSI prediction feature, corresponding to this feature, there may further be a functionality of low movement speed prediction and a functionality of high movement speed prediction.

A list of these sub-features or functionalities and related parameters thereof may be predefined and used for the common understanding of communication capability information between the network side and the terminal side.

To achieve a functionality, the terminal equipment may be specifically implemented by one AI/ML model or multiple AI/ML models.

In some embodiments, multiple functionalities may be implemented by one AI/ML model, depending on specific implementation of the terminal equipment, and methods and manners related to the implementation may not be necessarily notified to the network device.

In the embodiments of this disclosure, from the perspective of a logical model, it is generally defined that a model corresponding logically to a functionality is a logical model, and a logical model may be specifically implemented by one or more physical models. For the convenience of description, the embodiments of this disclosure does not further distinguish between logical models and physical models. That is, the model in the embodiments of this disclosure may be a logical model or a physical model.

In the embodiments of this disclosure, when a functionality is implemented by multiple models, different models may correspond to different scenarios, different sites, different cells, different configurations, and different applicable conditions, etc., which is determined by a training and development process of the models.

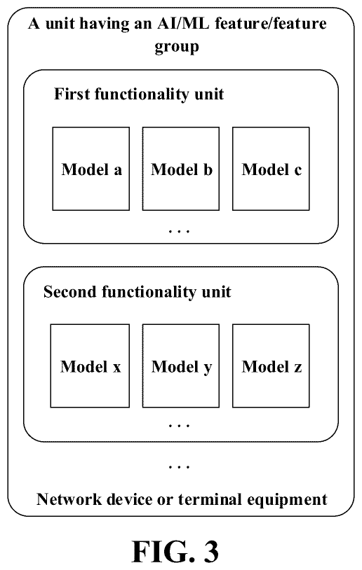

FIG. 3 is a schematic diagram of an equipment having an AI/ML functional module. The equipment may be a terminal equipment or a network device. The terminal equipment or the network device has an AI/ML functional module. For example, as shown in FIG. 3, the terminal equipment or the network device has a unit of an AI/ML feature/feature group, and there is at least one functionality unit in the unit of the AI/ML feature/feature group, such as a first functionality unit and a second functionality unit. For example, as shown in FIG. 3, the first functionality is implemented by at least one model from model a, model b and model c, etc., and the second functionality is implemented by at least one model from model x, model y and model z, etc. In some embodiments, the above functionality units may possibly also include multiple sub-functionalities, in which case a functionality unit may be regarded as a functionality group.

In the embodiments of this disclosure, the network device performs AI/ML-related capability enquiry on the terminal equipment, and the terminal equipment reports a corresponding capability according to the enquiry.

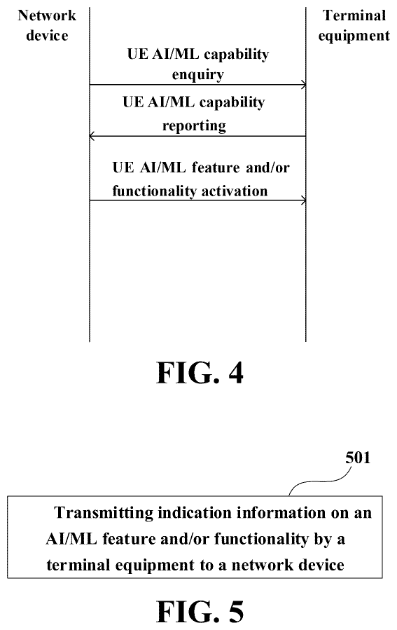

FIG. 4 is another schematic diagram of exchange between the network device and the terminal equipment. As shown in FIG. 4, the network device performs AI/ML-related capability enquiry on the terminal equipment, i.e. UE AI/ML capability enquiry, and the terminal equipment reports to the network device according to the enquiry, i.e. UE AI/ML capability reporting.

According to the UE AI/ML capability reporting, the network device further transmits a control message to activate or enable an AI/ML feature or feature group, or a specific functionality, of the terminal side. As shown in FIG. 4, the network device performs UE AI/ML feature and/or functionality activation on the terminal equipment.

In some embodiments, the activation may be achieved via the feature ID, sub-feature ID, functionality ID, or by a related configuration of a functionality. For example, in a CSI reporting configuration, a specific functionality may be activated by a configuration of an AI/ML IE.

Or, activation of a functionality may be indicated by an ID of the CSI reporting configuration or a resource (or resource set) configuration in combination with an AI/ML activation instruction, or equivalently, activation of AI/ML implementation to which the configuration corresponds.

After receiving relevant activation information, the terminal equipment enables a corresponding AI/ML model according to its implementation to perform measurement and reporting.

However, it was found by the inventor that there exists a problem that specific model information used by the terminal side does not need to be notified to the network side.

For example, corresponding to the first functionality, the number of models and which model or models are used by the terminal equipment, such as whether a model is used, such as model A, or whether model a and model b, or whether model a, model b and model c, etc., is/are used, are specific implementation information of the terminal, which are generally not needed to be notified to the network side.

For an AI/ML feature or functionality that is enabled or activated by the network side, the network side needs to perform basic performance monitoring on the feature or functionality. At the same time, when the terminal side implements the activated feature or functionality by using a specific model, model-level performance monitoring or input-output-related monitoring needs to be performed.

In addition, when an model or a group of models used by the terminal equipment is not adapted to a current application scenario or applicable condition, the terminal equipment may autonomously switch models or model groups.

Model switching at the terminal side may not be notified to the network side. However, due to lack of information on terminal model switching, the AI/ML functionality monitoring at the network side will transmit a command to activate or stop AI/ML features or functionalities to the terminal equipment when it determines that AI/ML performance is poor. This is actually an inappropriate operation because the performance of the terminal equipment after model switching may be very good.

### Embodiment of a First Aspect

The embodiments of this disclosure provide an information transmission method, which shall be described from a terminal equipment side.

FIG. 5 is a schematic diagram of the information transmission method of the embodiments of this disclosure. As shown in FIG. 5, the method includes:

501: transmitting indication information on an AI/ML feature and/or functionality by the terminal equipment to a network device.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In some embodiments, the AI/ML feature includes at least one AI/ML functionality, the AI/ML functionality being referred to as an AI/ML sub-feature.

In some embodiments, the AI/ML feature includes at least one AI/ML feature group.

In some embodiments, the AI/ML feature group includes at least one AI/ML functionality.

For example, an AI/ML feature or a feature group includes one or more AI/ML functionalities. For example, for a CSI prediction feature, corresponding to this feature, there may further be a functionality of low movement speed prediction and a functionality of high movement speed prediction.

In some embodiments, the AI/ML feature has an AI/ML feature identifier (feature ID).

The AI/ML functionality has an AI/ML functionality ID, or the AI/ML sub-feature has an AI/ML sub-feature ID.

In some embodiments, the indication information includes information an AI/ML feature and/or functionality that the terminal equipment expects to use.

In some embodiments, the AI/ML feature and/or functionality that the terminal equipment expects to use refer(s) to an AI/ML feature and/or functionality that is/are determined by the terminal equipment according to monitoring and measuring a model implementing an AI/ML feature and/or functionality to be suitable for operation.

Thus, for the model at the terminal side, model-based input-output signal analysis may provide a more accurate evaluation of model performance compared to network side monitoring. In addition, evaluation of performances of an AI/ML feature and/or functionality to which the model corresponds be may further inferred. Configuration by the network may allow or enable performance evaluation at an AI/ML functionality level at the terminal side and related reporting to the network device, thereby achieving precise AI/ML functionality monitoring, functionality activation and deactivation, functionality selection and functionality switching, and fallback to a non-AI/ML mode. The AI/ML functionality is effectively utilized to enhance communication quality.

In some embodiments, the terminal equipment transmits the indication information to the network device in one of the following cases that:
the network device transmits configuration and/or an indication of the indication information to the terminal equipment;
the network device transmits configuration and/or indication related to an AI/ML feature and/or functionality of the indication information to the terminal equipment;
the network device transmits a measurement judgment indication related to the AI/ML feature and/or functionality operation of the indication information to the terminal equipment; and
the network device transmits at least one of a measurement metric, a condition and a performance threshold related to the AI/ML feature and/or functionality operation of the indication information to the terminal equipment.

In some embodiments, the AI/ML feature and/or functionality operation includes at least one of monitoring, selecting, switching, activating and deactivating the AI/ML feature and/or functionality and making the AI/ML feature and/or functionality fallback to a non-AI/ML mode.

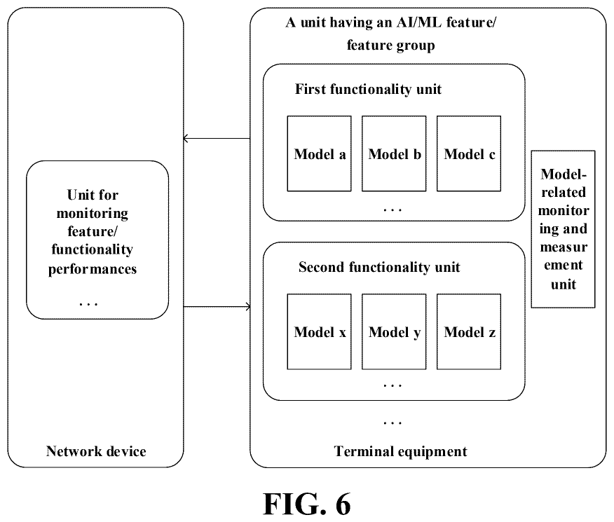

FIG. 6 is a modular schematic diagram of the network device and the terminal equipment. As shown in FIG. 6, the network device includes a monitoring unit of feature and/or functionality performance, and the terminal equipment includes a unit of an AI/ML feature/feature group. In the unit of the AI/ML feature/feature group, there exists at least one functionality unit, such as a first functionality unit and a second functionality unit. For example, as shown in FIG. 6, the first functionality is implemented by at least one model from model a, model b and model c, etc., and the second functionality is implemented by at least one model from model x, model y and model z, etc. In addition, in the unit of the AI/ML feature/feature group, there exists also a model-level monitoring unit, i.e. a model-related monitoring and measurement unit.

The method and operations of the terminal equipment and the network device of the embodiments of this disclosure shall be described below with reference to various application scenarios.

### Application Scenario 1: AI/ML Model Switching

In some embodiments, the indication information includes model indication information.

For example, the model indication information includes change information of a model or model group implementing the AI/ML feature and/or functionality.

In some embodiments, the change information of the model or model group includes at least one of the following information:
information on changes in a model or model groups;
identification information of the AI/ML feature and/or functionality and indication information of changes in the model or model group; and
identification information of the model or model group.

For example, the information on a change in the model or model group is represented by bit information. For example, a change in the model or model group is represented by 1 bit.

For example, the model or the model in the model group is in a bilateral model structure. The network device has a consistent understanding of the model identifier transmitted by the terminal. This identifier characterizes that a model or a model group at the terminal side may work together with a model or a model group at the network side, and sometimes they become paired identifiers.

In some embodiments, the model indication information is carried in relevant reporting information.

For example, the reporting information is CSI reporting information, and in an IE related to AI/ML in the CSI reporting configuration, indication information reporting that represents model changes is predefined.

In some embodiments, the terminal equipment transmits the model indication information to the network device via uplink signaling.

For example, the model indication information is carried by UCI or an MAC CE or RRC signaling.

In some embodiments, on a physical channel, the model indication information is transmitted via a PUCCH or a PUSCH.

The application scenario shall be described below with reference to the accompanying drawings.

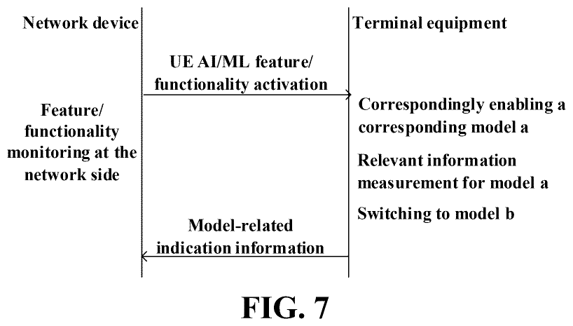

FIG. 7 is a schematic diagram of exchange between the network device and the terminal equipment in application scenario 1 in the embodiments of this disclosure. As shown in FIG. 7, the network device performs UE AI/ML feature and/or functionality activation on the terminal equipment. After the AI/ML feature and/or functionality is/are activated or enabled, the terminal equipment correspondingly starts model a to perform relevant signal processing and simultaneously measures model use, such as features of signals input and output by model a. If the terminal equipment determines to switch to model b based on its measurement or other reasons, the terminal equipment will transmit relevant indication information to the network device accordingly, i.e. model-related indication information.

Furthermore, it should be noted that the above description is also applicable to switching of model groups, such as switching from model group a to model group b. Here, each model group may correspond to multiple models under multiple sub-conditions of a condition applied by it.

In addition, the above description is also applicable to stop of the model or model group, and at this moment, the indication information of the model corresponds to the stop of the model.

Moreover, when the model indication information corresponds to different model operations, such as model switching, model stop, model starting, and model updating, etc., different model operations may be represented by multiple pieces of predefined bit information and taken as the model indication information.

The network side monitors performance of the AI/M feature and/or functionality activated by it. After receiving the model-related indication information transmitted by the terminal equipment, the network device may adjust its monitoring strategy accordingly, such as resetting a monitoring-related event counter, a timer, and a model monitoring calculation method, etc., that is, monitor and determining a corresponding signal transceiving performance after the terminal side switches the model. Thus, model monitoring and determination of activation performances by the network side may be more accurate.

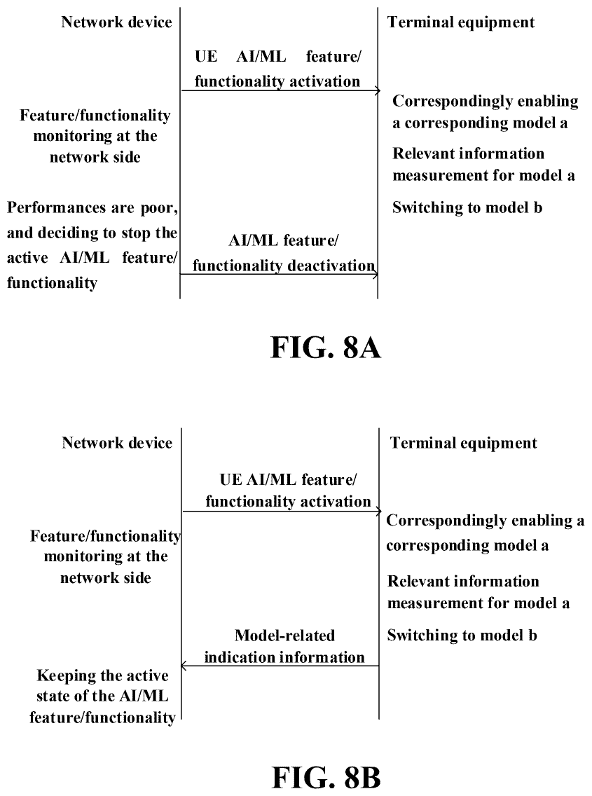

FIGS. 8A and 8B are schematic diagrams of comparison between an exchange process in the method of the embodiments of this disclosure and an exchange process in an existing method. As shown in FIG. 8A, in the existing method, when a network side monitors that performances of an AI/ML feature/functionality are poor, it decides to stop the AI/ML feature/functionality and transmits a deactivation command to a terminal side, and the terminal side may only stop using a model which it has just switched to and believed by it that may have good performance. This may lead to degradation in subsequent communication performance. On the contrary, as shown in FIG. 8B, in the embodiments of this disclosure, the network side readjusts its monitoring and decision-making strategy after receiving the model-related indication information. Even if performances of the monitored AI/ML feature/functionality are poor before the information is received, the network side may reset monitoring indices, proceed with keeping an active state of the AI/ML functionality, and further monitor a new model used by the terminal side. Hence, by continuously using the AI/ML functionality, the communication process may benefit from gains brought by the AI/ML functionality for a longer period of time.

Application Scenario 2: Deactivation of the AI/ML Feature and/or Functionality and/or Fallback to a Non-AI/ML Mode

In some embodiments, the indication information includes deactivation request information for an AI/ML feature and/or functionality in an active state and/or request information on fallback to a non-AI/ML mode.

In some embodiments, the deactivation request information includes at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

The application scenario shall be described below with reference to the accompanying drawings.

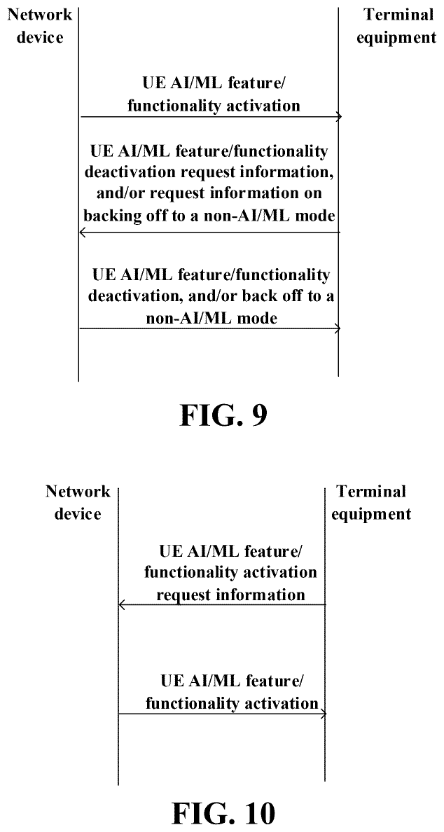

FIG. 9 is a schematic diagram of exchange between the network device and the terminal equipment in application scenario 2 in the embodiments of this disclosure. As shown in FIG. 9, the network device performs UE AI/ML feature and/or functionality activation on the terminal equipment. After the AI/ML feature and/or functionality is/are activated, the terminal side measures and monitors the model it uses. When the terminal side finds that performances of one or more models used by it is/are unable to satisfy certain conditions, the terminal side transmits deactivation request information for the activated AI/ML functionality, i.e. UE AI/ML feature and/or functionality deactivation request information, and/or request information for fallback to a non-AI/ML mode.

In the deactivation request information, indication information for activating the AI/ML feature and/or functionality may be included, such as functionality ID information, and deactivation indication information.

In the deactivation request information, information on applicability of the deactivation information, and quality information on a signal used for judgment, such as information on an SINR, and RSRP, may further be included.

In the deactivation request information, an ID of the CSI reporting configuration or resource (or resource set) configuration may further be included, which is used to, together with the AI/ML deactivation indication, indicate that a certain functionality is expected to be deactivated, or equivalently, is an AI/ML method to which deactivating the configuration corresponds.

In some embodiments, the request information for fallback to the non-AI/ML mode may include suggested configuration information, and parameter information, etc., related to the non-AI/ML mode.

After receiving the deactivation request information, the network device determines that the AI/ML feature and/or functionality may be deactivated, and/or that it may fallback to the non-AI/ML mode, hence, it transmits indication information for deactivation of the UE AI/ML feature and/or functionality and/or indication information for fallback to the non-AI/ML mode to the terminal equipment.

Application Scenario 3: Activation of the AI/ML Feature and/or Functionality

The indication information includes activation request information for an AI/ML feature and/or functionality in an inactive state.

In some embodiments, the activation request information includes at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

The application scenario shall be described with reference to the accompanying drawings.

FIG. 10 is a schematic diagram of exchange between the network device and the terminal equipment in application scenario 3 in the embodiments of this disclosure. As shown in FIG. 10, for an AI/ML feature and/or functionality in an inactive state, if the terminal equipment determines that it is suitable to run the AI/ML feature and/or functionality after measuring or monitoring input or output related to the model, it transmits an activation request for starting the AI/ML to the network device, the request information including functionality indication information, or configuration indication information, etc., that is, transmitting UE AI/ML feature and/or functionality activation request information. After receiving the deactivation request information, if the network device determines that the AI/ML feature and/or functionality may be activated, it transmits indication information for activating the UE AI/ML feature and/or functionality to the terminal equipment.

In the activation request information, indication information for expecting activating the AI/ML feature and/or functionality may be included, such as a feature ID and/or a functionality ID, and/or request information or indication information for activating AI/ML may be included. Thus, a request for an AI/ML method for activating CSI prediction, and a request for an AI/ML method for activating beam time domain or spatial domain prediction, etc., may be indicated.

In addition, the activation request information, information on applicability of the deactivation information, and quality information on a signal used for judgment, such as information on an SINR, and RSRP, may further be included.

Moreover, in the activation request information, an ID of the CSI reporting configuration or resource (or resource set) configuration may further be included, which is used to, together with the AI/ML deactivation indication, indicate that a certain functionality is expected to be deactivated, or equivalently, is an AI/ML method to which deactivating the configuration corresponds.

Application Scenario 4: Selection of an AI/ML Feature and/or Functionality

In some embodiments, the indication information includes indication information of the AI/ML feature and/or functionality selected by the terminal equipment.

In some embodiments, the indication information includes at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

In some embodiments, the method further includes: receiving, by the terminal equipment, the measurement configuration information and/or reporting configuration information transmitted by the network device.

In some embodiments, the measurement configuration information includes at least one of configuration of a CSI resource configuration or CSI resource set configuration and configuration of a type of RS.

In some embodiments, one configuration in the measurement configuration information and/or the reporting configuration information corresponds to implementation of at least one AI/ML feature and/or functionality.

In some embodiments, the measurement configuration information and/or reporting configuration information include(s) evaluation indication information of the AI/ML feature and/or functionality, or selection indication information of the AI/ML feature and/or functionality.

In some embodiments, the measurement configuration information and/or reporting configuration information is/are configured via an identifier/identifiers of the AI/ML feature and/or functionality.

For example, the AI/ML feature and/or functionality to which the measurement configuration information and/or the reporting configuration information correspond(s) is/are determined by the network device according to the AI/ML feature and/or functionality supported by the terminal equipment reported by the terminal equipment.

In some embodiments, the measurement configuration information and/or reporting configuration information is/are configured via RRC, or, at least one measurement configuration and/or reporting configuration is/are activated by an MAC CE after the measurement configuration information and/or reporting configuration information is/are configured via RRC.

In some embodiments, the measurement configuration information and/or reporting configuration information includes evaluation indication information for AI/ML.

The application scenario shall be described below with reference to the accompanying drawings.

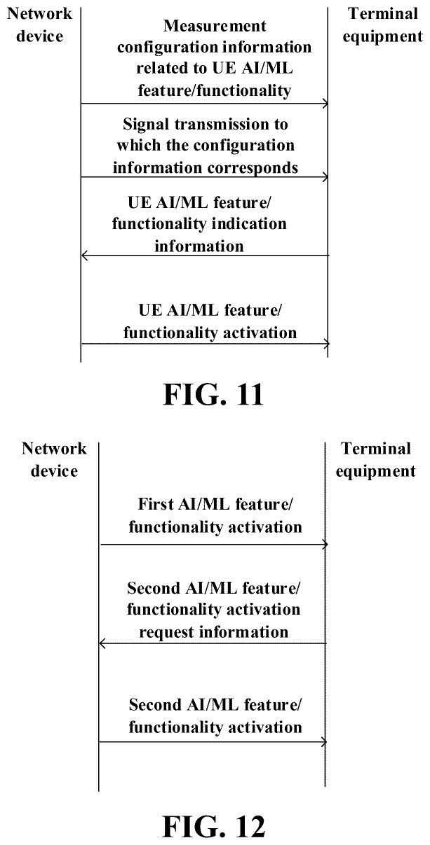

FIG. 11 is a schematic diagram of exchange between the network device and the terminal equipment in application scenario 4 in the embodiments of this disclosure. As shown in FIG. 11, the network device transmits UE AI/ML feature and/or functionality related measurement configuration information to the terminal equipment, that is, the network side configures and transmits measurement configuration information suitable for the terminal side to execute one or more AI/ML features and/or functionalities, such as a configuration of a CSI resource or resource set, and a configuration of an RS, etc.

For example, a configuration may possibly correspond to implementation of one or more functionalities, including AI/ML feature and/or functionality evaluation indication information or functionality selection indication information, or is configured via a functionality ID.

In some embodiments, the measurement configuration information may be configured via RRC, or may be configured by an MAC CE by activating one or more measurement configurations after the configuration via RRC is completed, such as a configuration of a resource or resource set corresponding to CSI or an RS.

In some embodiments, the measurement configuration information may be configured via RRC, or may be configured by an MAC CE by activating one or more reporting configurations after the configuration via RRC is completed, such as a reporting configuration corresponding to CSI.

In some embodiments, the measurement configuration information includes an evaluation indication for AI/ML.

In some embodiments, according to the AI/ML feature and/or functionality supported by the terminal equipment reported thereby, the network selects one or more AI/ML features and/or functionalities that the network device also supports or expects the terminal to use and configures them for the terminal equipment. A configuration method is as described above, which may include a functionality ID, or may include measurement configuration information to which an AI/ML feature and/or functionality correspond(s), such as a configuration of a CSI resource or resource set, or may include a reporting configuration to which the AI/ML feature and/or functionality correspond(s).

The network side transmits configuration-related signals, such as a CSI-RS, and an SSB, etc., and it may possibly further perform beamforming or precoding related to functional configuration on transmitted signal, and then transmit them.

The terminal side measures, monitors and judges different models belonging to the one or more AI/ML features and/or functionalities according to the received signal configuration and AI/ML feature and/or functionality evaluation indication information or functionality selection indication information, and selects a suitable model or a suitable AI/ML feature and/or functionality, or makes a judgment on whether it is suitable to activate an AI/ML feature and/or functionality.

Subsequently, the terminal equipment transmits AI/ML feature and/or functionality indication information.

In some embodiments, the indication information may include information on the selected feature ID or functionality ID, or, configuration indication information for resource configuration or reporting configuration of the network, such as selecting an ID from configuration IDs configured by the network side.

In some embodiments, the indication information may include information on the degree of determination of the activation information, quality information of the signal used to determine activation, such as SINR, RSRP information.

After receiving the AI/ML feature and/or functionality indication information, the network device may determine that the AI/ML feature and/or functionality may be activated, and then transmits the indication information for activating the UE AI/ML feature and/or functionality to the terminal equipment.

Application Scenario 5: Switching of the AI/ML Feature and/or Functionality

In some embodiments, the indication information includes switching request information for the AI/ML feature and/or functionality, or activation request information of an AI/ML feature and/or functionality taken as a switching target.

In some embodiments, the indication information includes at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

In some embodiments, the method further includes: determining by the terminal equipment whether to switch the AI/ML feature and/or functionality according to evaluation index information for switching the AI/ML feature and/or functionality configured by the network side.

In some embodiments, the evaluation index information includes at least one of a measurement index, a measurement threshold, a comparison index, and a comparison threshold.

In some embodiments, the indication information includes at least one of input configuration-related information and output configuration-related information to which the AI/ML feature and/or functionality corresponds.

The application scenario shall be descried below with reference to the accompanying drawings.

FIG. 12 is a schematic diagram of exchange between the network device and the terminal equipment in application scenario 5 in the embodiments of this disclosure. As shown in FIG. 12, the network device activates an AI/ML feature and/or functionality of the terminal, such as a first AI/ML feature and/or functionality. In addition, the network device configures a grant for the terminal side to make a request for switch of an AI/ML feature and/or functionality, or, the network device configures other AI/ML feature and/or functionality resource configurations for the terminal equipment, but in the reporting configuration, it does not requires the terminal equipment to report, such as configuring via RRC, and/or an MAC CE, etc. Furthermore, the network device configures criteria for judging switch of an AI/ML feature and/or functionality for terminal, such as a measurement threshold, a comparison index, and a comparison threshold, etc. The network side transmits configuration-related signals, such as CSI-RSs, and SSBs, etc.

The terminal equipment evaluates possible performance expectations of the AI/ML feature and/or functionality in an inactive state accordingly. The terminal equipment may analyze input and output data of an inactive model implementing the AI/ML feature and/or functionality, and compare with the active model with respect to performances.

The terminal equipment determines whether the inactive model is superior to the active model according to the measurement index, comparison index, and comparison threshold, etc. configured by the network side, and selects an inactive AI/ML feature and/or functionality that is/are superior to an existing AI/ML feature and/or functionality, such as a second AI/ML feature and/or functionality.

The terminal equipment transmits AI/ML feature and/or functionality switch request information, or second AI/ML feature and/or functionality activation request information.

In some embodiments, the request information may include information on the selected feature ID and/or functionality ID, or configuration indication information corresponding to the second functionality, such as a configuration ID.

In some embodiments, the indication information may include information on the degree of determination of the activation information, quality information of the signal used to determine activation, such as SINR, RSRP information.

For example, for application scenarios 4 and 5 above, taking a beam management feature as an example, it has the following two functionalities:
first functionality: a model to which this functionality belongs corresponds to a case of CSI resource configuration or resource configuration set 1 (including configuration information of a CSI-RS and/or an SSB) and where the number of spatial domain beams transmitted by a corresponding network device is large;
second functionality: a model to which this functionality belongs corresponds to a case of CSI resource configuration or resource configuration set 2 (including configuration information of a CSI-RS and/or an SSB) and where the number of spatial domain beams transmitted by a corresponding network device is small.

The terminal equipment determines which functionality is more suitable according to an SSB or CSI-RS measured by it and output of the model, and transmits functionality indication information accordingly.

For example, the functionality indication information may be CSI configuration-related indication information, such as parameter information related to a configured ID, or SSB, CSI-RS.

For example, the functionality indication information may be functionality ID information, or other predefined functionality parameter information.

For example, the functionality indication information may be other information that enables a base station to understand a functionality to which the information corresponds.

In some embodiments, the functionality indication information and its corresponding functionality are predefined.

Another type is related to corresponding CSI prediction, and the configuration is a time period or frequency domain density corresponding to a CSI-RS, etc., or a configuration for its measurement window parameters.

That is, the terminal side transmits information related the input configuration to which the functionality corresponds.

In addition, the terminal equipment may also transmit information related to functionality output configuration, such as time-domain prediction of corresponding beams, quantity configuration of prediction, and configuration information of prediction windows, etc.

That is, the terminal side transmits the information related to the output configuration to which the functionality corresponds, i.e. reporting configuration information related to the functionality, such as a reporting configuration ID.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment transmits the indication information related to the AI/ML feature and/or functionality to the network device, so that the network device may timely and accurately an actual performance of the AI/ML feature and/or functionality, and achieve accurate operations of the AI/ML feature and/or functionality, thereby fully utilizing the AI/ML functionalities to improve communication quality, and improving performances of the communication system.

### Embodiment of a Second Aspect

The embodiments of this disclosure provide an information transmission method, which shall be described from a network device side. This method corresponds to the embodiment of the first aspect, which contents identical to those in the embodiment of the first aspect being not going to be repeated herein any further.

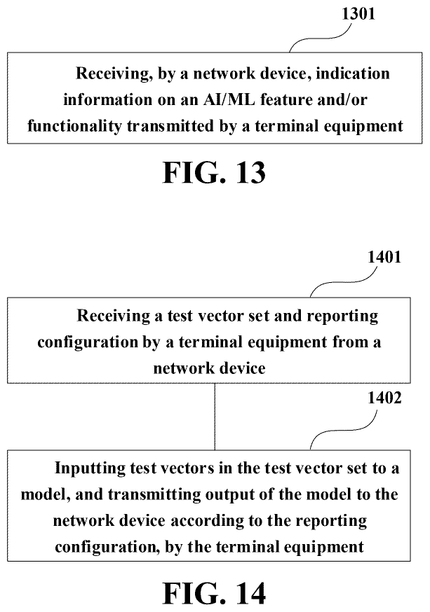

FIG. 13 is another schematic diagram of the information transmission method of the embodiments of this disclosure. As shown in FIG. 13, the method includes:

1301: receiving, by a network device, indication information on an AI/ML feature and/or functionality transmitted by a terminal equipment.

It should be noted that FIG. 13 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 13.

In some embodiments, the indication information includes information an AI/ML feature and/or functionality that the terminal equipment expects to use.

In some embodiments, the method further includes one of the following steps:
transmitting configuration and/or an indication of the indication information by the network device to the terminal equipment;
transmitting configuration and/or indication related to an AI/ML feature and/or functionality of the indication information by the network device to the terminal equipment;
transmitting a measurement judgment indication related to the AI/ML feature and/or functionality operation of the indication information by the network device to the terminal equipment; and
transmitting at least one of a measurement metric, a condition and a performance threshold related to the AI/ML feature and/or functionality operation of the indication information by the network device to the terminal equipment.

In some embodiments, the AI/ML feature and/or functionality operation includes at least one of monitoring, selecting, switching, activating and deactivating the AI/ML feature and/or functionality and making the AI/ML feature and/or functionality fallback to a non-AI/ML mode.

In some embodiments, the indication information includes indication information of the AI/ML feature and/or functionality selected by the terminal equipment.

In some embodiments, the indication information includes at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

In some embodiments, the method further includes:

transmitting measurement configuration information and/or reporting configuration information by the network device to the terminal equipment.

In some embodiments, the measurement configuration information includes at least one of configuration of a CSI resource configuration or CSI resource set configuration and configuration of a type of RS.

In some embodiments, one configuration in the measurement configuration information and/or the reporting configuration information corresponds to implementation of at least one AI/ML feature and/or functionality.

In some embodiments, the measurement configuration information and/or reporting configuration information include(s) evaluation indication information of the AI/ML feature and/or functionality, or selection indication information of the AI/ML feature and/or functionality.

In some embodiments, the measurement configuration information and/or reporting configuration information is/are configured via an identifier/identifiers of the AI/ML feature and/or functionality.

In some embodiments, the AI/ML feature and/or functionality to which the measurement configuration information and/or the reporting configuration information correspond(s) is/are determined by the network device according to the AI/ML feature and/or functionality supported by the terminal equipment reported by the terminal equipment.

In some embodiments, the measurement configuration information and/or reporting configuration information is/are configured via RRC, or,

at least one measurement configuration and/or reporting configuration is/are activated by an MAC CE after the measurement configuration information and/or reporting configuration information is/are configured via RRC.

In some embodiments, the measurement configuration information and/or reporting configuration information includes evaluation indication information for AI/ML.

In some embodiments, the indication information includes switching request information for the AI/ML feature and/or functionality, or activation request information of an AI/ML feature and/or functionality taken as a switching target.

In some embodiments, the indication information includes at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

In some embodiments, the method further includes:

configuring evaluation index information for switching the AI/ML feature and/or functionality for the terminal equipment by the network side.

In some embodiments, the evaluation index information includes at least one of a measurement index, a measurement threshold, a comparison index, and a comparison threshold.

In some embodiments, the indication information includes at least one of input configuration-related information and output configuration-related information to which the AI/ML feature and/or functionality corresponds.

In some embodiments, the indication information includes model indication information.

In some embodiments, the model indication information includes change information of a model or model group implementing the AI/ML feature and/or functionality.

In some embodiments, the change information of the model or model group includes at least one of the following information:
information on changes in a model or model groups;
identification information of the AI/ML feature and/or functionality and indication information of changes in the model or model group; and
identification information of the model or model group.

In some embodiments, the information on a change in the model or model group is represented by bit information.

In some embodiments, a change in the model or model group is represented by 1 bit.

In some embodiments, the model or the model in the model group is in a bilateral model structure.

In some embodiments, the model indication information is carried in relevant reporting information.

In some embodiments, the reporting information is CSI reporting information, and in an IE related to AI/ML in the CSI reporting configuration, indication information reporting that represents model changes is predefined.

In some embodiments, the model indication information is transmitted via uplink signaling.

In some embodiments, the model indication information is carried by UCI or an MAC CE or RRC signaling.

In some embodiments, on a physical channel, the model indication information is transmitted via a PUCCH or a PUSCH.

In some embodiments, the indication information includes deactivation request information for an AI/ML feature and/or functionality in an active state and/or request information on fallback to a non-AI/ML mode.

In some embodiments, the deactivation request information includes at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

The indication information includes activation request information for an AI/ML feature and/or functionality in an inactive state.

In some embodiments, the activation request information includes at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

In some embodiments, the AI/ML feature includes at least one AI/ML functionality.

In some embodiments, the AI/ML feature includes at least one AI/ML feature group.

In some embodiments, the AI/ML feature group includes at least one AI/ML functionality.

In some embodiments, the AI/ML functionality is an AI/ML sub-feature.

In some embodiments, the AI/ML feature includes an AI/ML feature identifier.

In some embodiments, the AI/ML functionality includes an AI/ML functionality identifier, or, the AI/ML sub-feature includes an AI/ML sub-feature identifier.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the network device receives the indication information related to the AI/ML feature and/or functionality from the terminal equipment, so that the network device may timely and accurately an actual performance of the AI/ML feature and/or functionality, and achieve accurate operations of the AI/ML feature and/or functionality, thereby fully utilizing the AI/ML functionalities to improve communication quality, and improving performances of the communication system.

### Embodiment of a Third Aspect

The embodiments of this disclosure provide a method for verifying performances of a model.

FIG. 14 is a schematic diagram of the method for verifying performances of a model of the embodiments of this disclosure, corresponding to a terminal side. As shown in FIG. 14, the method includes:
1401: receiving a test vector set and reporting configuration by a terminal equipment from a network device; and
1402: inputting test vectors in the test vector set to a model, and transmitting output of the model to the network device according to the reporting configuration, by the terminal equipment.

In some embodiments, the test vector set is carried by RRC.

In some embodiments, a correspondence between the test vectors in the test vector set and the model is indicated by indication information transmitted by the network device, or the test vector set includes an identifier corresponding to the model.

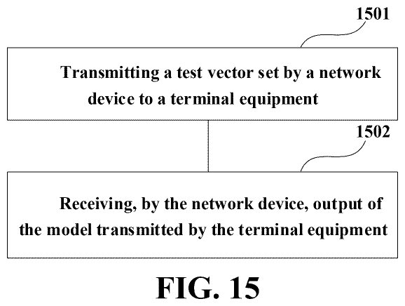

FIG. 15 is another schematic diagram of the method for verifying performances of a model of the embodiments of this disclosure, corresponding to a network side. As shown in FIG. 15, the method includes:
1501: transmitting a test vector set by the network device to a terminal equipment; and
1502: receiving, by the network device, output of the model transmitted by the terminal equipment.

In some embodiments, the network device transmits the test vector set to the terminal equipment via an RRC message.

In some embodiments, a correspondence between the test vectors in the test vector set and the model is indicated by indication information transmitted by the network device, or the test vector set includes an identifier corresponding to the model.

In some embodiments, the method further includes: informing the terminal equipment of a use of the test vector set via a specific RRC message or other bound configurations, and transmitting relevant reporting configurations, by the network device.

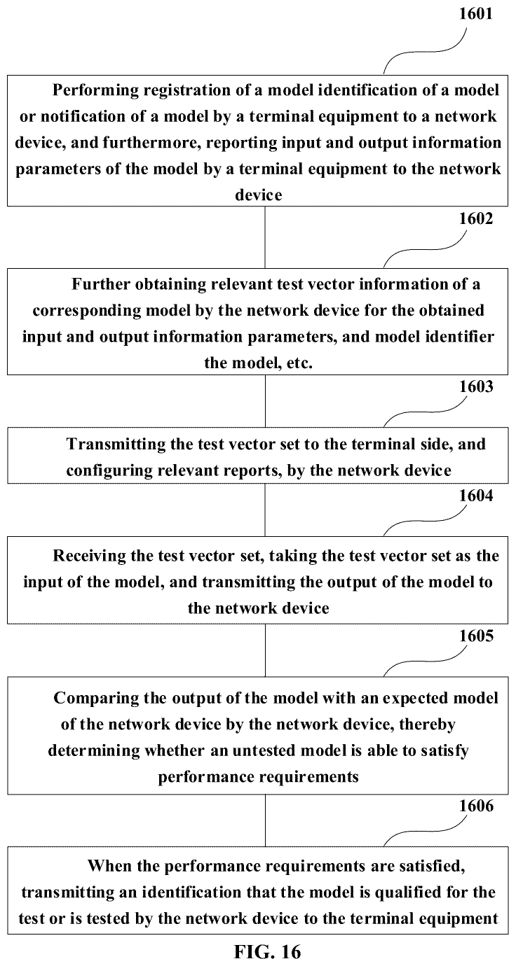

FIG. 16 is a further schematic diagram of the method for verifying performances of a model of the embodiments of this disclosure, corresponding to a network side and a terminal side. As shown in FIG. 16, the method includes:
1601: performing registration of a model identification of a model or notification of a model by a terminal equipment to a network device, including an indication that the model has not undergone the testing, and furthermore, reporting input and output information parameters of the model by the terminal equipment to the network device;
1602: further obtaining relevant test vector information of a corresponding model (such as based on a model identifier) by the network device for the input and output information parameters, and model identifier the model, etc.;
wherein for this test vector, one part corresponds to the input of the model, and the other part corresponds to output that a qualified model should have;
1603: transmitting the test vector set to the terminal side, and configuring relevant reports, by the network device, the test vector corresponding to the model input;
1604: receiving the test vector set, taking the test vector set as the input of the model, and transmitting the output of the model to the network device according to the reporting configuration, by the terminal equipment;
1605: comparing the output of the model with an expected model (e.g. based on a model identifier) of the network device by the network device, thereby determining whether an untested model is able to satisfy performance requirements; and
1606: when the performance requirements are satisfied, transmitting an identification that the model is qualified for the test or is tested by the network device to the terminal equipment.

In some embodiments, if it is assumed that an untested model does not have a global identifier, the network side transmits a global identifier to the model after the test is qualified.

In some embodiments, the test vector set may be carried by RRC, and model to which it corresponds is notified to the terminal equipment via indication information, such as a model identifier, or, a dataset of the test vector has an identifier corresponding to the model.

Furthermore, the network device informs the terminal equipment of a use of the test vector set via a specific RRC message or other bound configurations, and transmits relevant reporting configurations.

In some embodiments, the test includes at least one of interoperability testing, RAN4 test, and network access test.

It can be seen from the above embodiment that the network device transmits a dataset to the terminal equipment, and the dataset may be taken as a test vector to verify performances of the model of the terminal.

### Embodiment of a Fourth Aspect

The embodiments of this disclosure provide a method for identifying an AI/ML model.

In order to be adapted to different application scenarios, configurations, and applicable conditions, etc., a terminal equipment or a network device may use multiple AI/ML models for a functionality or a functionality module. The terminal equipment or the network device may not have undergone or have not undergone sufficient RAN4 test, network access test, or other types of interoperability test before using these models in the network. Performances of these models need to be further verified before they are used in a current network or are activated. On the other hand, for an inactive model, certain performance evaluation is also required before the model is activated.

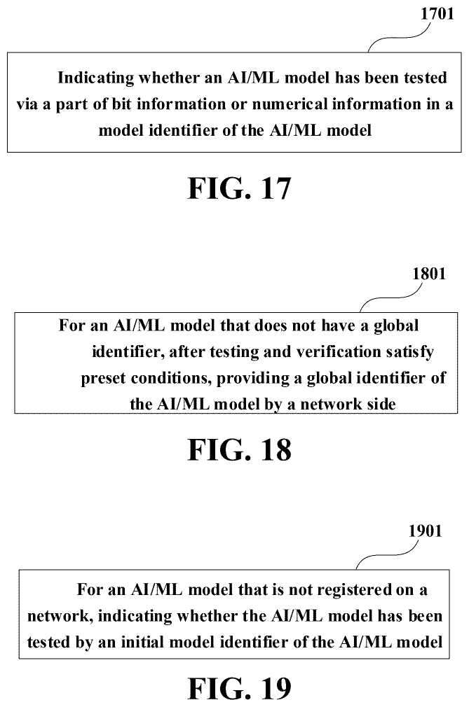

FIG. 17 is a schematic diagram of a method for identifying an AI/ML model of the embodiments of this disclosure. As shown in FIG. 17, the method includes:

1701: indicating whether an AI/ML model has been tested via a part of bit information or numerical information in a model identifier of the AI/ML model.

In some embodiments, the model identifier is a global identifier.

In some embodiments, whether the AI/ML model has been tested is indicated by a bit or a number in a bit string or number string of the model identifier.

That is, an explicit indication is introduced to mark tested models and untested models. The indication may be indicating by the part of bit information or numerical information in the model identifier, for example, 1 in the bit string or numerical string of the model identifier is used to represent that it has been tested, and 0 therein is used to represent that it has not been tested.

In some embodiments, the indication may be that an untested model does not have a model identifier, and only a tested model has an identifier.

The above model identifier is a global identifier, which may be given offline, or may be given when the model is registered in the network.

In some embodiments, the test includes at least one of interoperability test, RAN4 test and network access test.

On the other hand, for a model that has not undergone interoperability test, RAN4 test and network access test, it does not have an initial global model identifier, and needs to undergo an online testing verification process. After the test and verification satisfy requirements on performances, the network side confers a global model in a process of model registration or model identification.

Specifically, it may be that the network device transmits relevant model information to a network element responsible for managing global model identifiers after the model testing and verification satisfy preset conditions, so as to obtain the global identifier.

Or, after the model testing and verification satisfy the conditions, the terminal equipment initiates a model registration or recognition request for the model to the network side, transmits relevant model information to the network element responsible for managing global model identifiers, and obtains the global identifier.

FIG. 18 is another schematic diagram of the method for identifying an AI/ML model of the embodiments of this disclosure. As shown in FIG. 18, the method includes:

1801: for an AI/ML model that does not have a global identifier, after testing and verification satisfy preset conditions, providing a global identifier of the AI/ML model by a network side.

In some embodiments, after testing and verification satisfy preset conditions, the network side provides a global identifier of the AI/ML model in a process of model registration or model identification.

In some embodiments, after testing and verification satisfy preset conditions, the network device or terminal equipment transmits relevant model information to a network element responsible for managing global model identifiers, and obtains a global identifier of the AI/ML model from the network element.

In some embodiments, the test includes at least one of interoperability test, RAN4 test, and network access test.

Or, for all models that are not registered on the network, their initial model identifiers include identifications of whether they have passed interoperability test, RAN4 test, and network access test, etc. For models that have not undergone the above test, they need to be registered on the network, and undergo a necessary testing and verification process before being used, and after conditions are satisfied, they are granted relevant permissions or initial identification information.

Based on these permission information or initial identification information, the terminal side or base station initiates a model registration or model recognition request for the model to the network side, transmits relevant model information to the network element responsible for managing global model identifiers, and obtains the global identifier.

FIG. 19 is a further schematic diagram of the method for identifying an AI/ML model of the embodiments of this disclosure. As shown in FIG. 19, the method includes:

1901: for an AI/ML model that is not registered on a network, indicating whether the AI/ML model has been tested by an initial model identifier of the AI/ML model.

In some embodiments, the test includes at least one of interoperability test, RAN4 test, and network access test.

### Embodiment of a Fifth Aspect

The embodiments of this disclosure provide an information transmission apparatus. The apparatus may be, for example, a terminal equipment, or may be one or some components or assemblies configured in the terminal equipment, with contents identical to those in the embodiment of the first aspect being not going to be described herein any further.

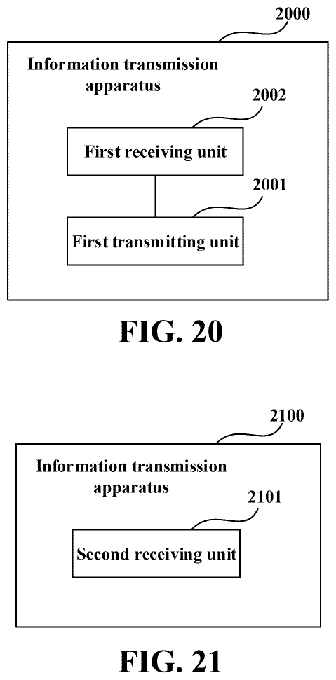

FIG. 20 is a schematic diagram of the information transmission apparatus of the embodiments of this disclosure. As shown in FIG. 20, an information transmission apparatus 2000 includes:

a first transmitting unit 2001 configured to transmit indication information on an AI/ML feature and/or functionality to a network device.

In some embodiments, the indication information includes information on an AI/ML feature and/or functionality that the terminal equipment expects to use.

In some embodiments, the first transmitting unit 2001 transmits the indication information to the network device in one of the following cases that:
the network device transmits configuration and/or an indication of the indication information to the terminal equipment;
the network device transmits configuration and/or indication related to an AI/ML feature and/or functionality of the indication information to the terminal equipment;
the network device transmits a measurement judgment indication related to the AI/ML feature and/or functionality operation of the indication information to the terminal equipment; and
the network device transmits at least one of a measurement metric, a condition and a performance threshold related to the AI/ML feature and/or functionality operation of the indication information to the terminal equipment.

In some embodiments, the AI/ML feature and/or functionality operation includes at least one of monitoring, selecting, switching, activating and deactivating the AI/ML feature and/or functionality and making the AI/ML feature and/or functionality fallback to a non-AI/ML mode.

In some embodiments, the indication information includes indication information on an AI/ML feature and/or functionality selected by the terminal equipment.

In some embodiments, the indication information includes at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

In some embodiments, as shown in FIG. 20, the apparatus further includes:

a first receiving unit 2002 configured to receive the measurement configuration information and/or reporting configuration information transmitted by the network device.

In some embodiments, the measurement configuration information includes at least one of configuration of a CSI resource configuration or CSI resource set configuration and configuration of a type of RS.

In some embodiments, the indication information includes switching request information for the AI/ML feature and/or functionality, or activation request information of an AI/ML feature and/or functionality taken as a switching target.

In some embodiments, the indication information includes at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

In some embodiments, the indication information includes model indication information.

In some embodiments, the model indication information includes change information of a model or model group that implements the AI/ML feature and/or functionality.

In some embodiments, the change information of the model or model group includes at least one piece of the following information:
information on changes in the model or model group;
identification information of the AI/ML feature and/or functionality and indication information of changes in the model or model group; and
identification information of the model or model group.

In some embodiments, the model indication information is carried in relevant reporting information.

In some embodiments, the first transmitting unit 2001 transmits the model indication information to the network device via uplink signaling.

In some embodiments, the indication information includes deactivation request information for an AI/ML feature and/or functionality in an active state and/or request information on fallback to a non-AI/ML mode.

In some embodiments, the deactivation request information includes at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

In some embodiments, the indication information includes activation request information for an AI/ML feature and/or functionality in an inactive state.

In some embodiments, the activation request information includes at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

Furthermore, for the sake of simplicity, connection relationships between the components or modules or signal profiles thereof are only illustrated in FIG. 20. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that the terminal equipment transmits the indication information related to the AI/ML feature and/or functionality to the network device, so that the network device may timely and accurately an actual performance of the AI/ML feature and/or functionality, and achieve accurate operations of the AI/ML feature and/or functionality, thereby fully utilizing the AI/ML functionalities to improve communication quality, and improving performances of the communication system.

### Embodiment of a Sixth Aspect

The embodiments of this disclosure provide an information transmission apparatus. The apparatus may be, for example, a network device, or may be one or some components or assemblies configured in the network device. This apparatus corresponds to the embodiment of second aspect, with contents identical to those in the embodiment of the second aspect being not going to be described herein any further.

FIG. 21 is a schematic diagram of the information transmission apparatus of the embodiments of this disclosure. As shown in FIG. 21, the information transmission apparatus 2100 includes:

a second receiving unit 2101 configured to receive indication information on an AI/ML feature and/or functionality transmitted by a terminal equipment.

It should be noted that the components or modules related to this disclosure are only described above. However, this disclosure is not limited thereto, and the information transmission apparatus 2100 may further include other components or modules, and reference may be made to related techniques for particulars of these components or modules.

Furthermore, for the sake of simplicity, connection relationships between the components or modules or signal profiles thereof are only illustrated in FIG. 5. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that the network device receives the indication information related to the AI/ML feature and/or functionality from the terminal equipment, so that the network device may timely and accurately an actual performance of the AI/ML feature and/or functionality, and achieve accurate operations of the AI/ML feature and/or functionality, thereby fully utilizing the AI/ML functionalities to improve communication quality, and improving performances of the communication system.

### Embodiment of a Seventh Aspect

The embodiments of this disclosure provide a terminal equipment, including the information transmission apparatus as described in the embodiment of the fifth aspect.

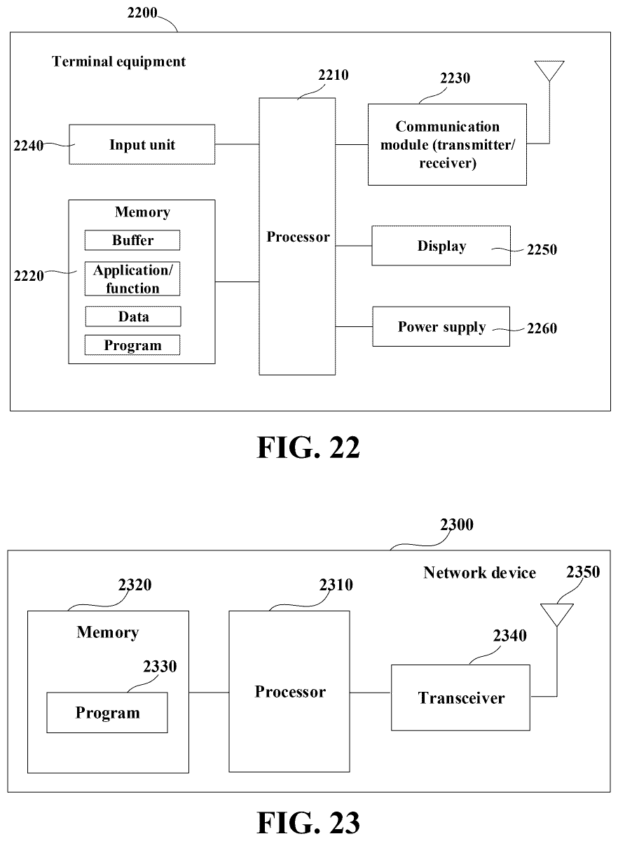

FIG. 22 is a schematic diagram of a systematic structure of the terminal equipment of the embodiments of this disclosure. As shown in FIG. 22, a terminal equipment 2200 may include a processor 2210 and a memory 2220, the memory 2220 being coupled to the processor 2210. It should be noted that this figure is illustrative only, and other types of structures may also be used, so as to supplement or replace this structure and achieve a telecommunications function or other functions.

In one implementation, the functions of the information transmission apparatus may be integrated into the processor 2210.

The processor 2210 is configured to: transmit indication information on an AI/ML feature and/or functionality to a network device.

In some embodiments, the indication information includes information on an AI/ML feature and/or functionality that the terminal equipment expects to use.

In some embodiments, the terminal equipment transmits the indication information to the network device in one of the following cases that:
the network device transmits configuration and/or an indication of the indication information to the terminal equipment;
the network device transmits configuration and/or indication related to an AI/ML feature and/or functionality of the indication information to the terminal equipment;
the network device transmits a measurement judgment indication related to the AI/ML feature and/or functionality operation of the indication information to the terminal equipment; and
the network device transmits at least one of a measurement metric, a condition and a performance threshold related to the AI/ML feature and/or functionality operation of the indication information to the terminal equipment.

In some embodiments, the AI/ML feature and/or functionality operation includes at least one of monitoring, selecting, switching, activating and deactivating the AI/ML feature and/or functionality and making the AI/ML feature and/or functionality fallback to a non-AI/ML mode.

In some embodiments, the indication information includes indication information on an AI/ML feature and/or functionality selected by the terminal equipment.

In some embodiments, the indication information includes at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

In some embodiments, the processor 2210 is further configured to: receive the measurement configuration information and/or reporting configuration information transmitted by the network device.

In some embodiments, the measurement configuration information includes at least one of configuration of a CSI resource configuration or CSI resource set configuration and configuration of a type of RS.

In some embodiments, one configuration in the measurement configuration information and/or the reporting configuration information corresponds to implementation of at least one AI/ML feature and/or functionality.

In some embodiments, the measurement configuration information and/or reporting configuration information include(s) evaluation indication information of the AI/ML feature and/or functionality, or selection indication information of the AI/ML feature and/or functionality.

In some embodiments, the measurement configuration information and/or reporting configuration information is/are configured via an identifier/identifiers of the AI/ML feature and/or functionality.

In some embodiments, the AI/ML feature and/or functionality to which the measurement configuration information and/or the reporting configuration information correspond(s) is/are determined by the network device according to the AI/ML feature and/or functionality supported by the terminal equipment reported by the terminal equipment.

In some embodiments, the measurement configuration information and/or reporting configuration information is/are configured via RRC, or,

at least one measurement configuration and/or reporting configuration is/are activated by an MAC CE after the measurement configuration information and/or reporting configuration information is/are configured via RRC.

In some embodiments, the measurement configuration information and/or reporting configuration information includes evaluation indication information for AI/ML.

In some embodiments, the indication information includes switching request information for the AI/ML feature and/or functionality, or activation request information of an AI/ML feature and/or functionality taken as a switching target.

In some embodiments, the indication information includes at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

In some embodiments, the processor 2210 is further configured to:

determine whether to switch the AI/ML feature and/or functionality according to evaluation index information for switching the AI/ML feature and/or functionality configured by the network side.

In some embodiments, the evaluation index information includes at least one of a measurement index, a measurement threshold, a comparison index, and a comparison threshold.

In some embodiments, the indication information includes at least one of input configuration-related information and output configuration-related information to which the AI/ML feature and/or functionality corresponds.

In some embodiments, the indication information includes model indication information.

In some embodiments, the model indication information includes change information of a model or model group implementing the AI/ML feature and/or functionality.

In some embodiments, the change information of the model or model group includes at least one of the following information:
information on changes in a model or model groups;
identification information of the AI/ML feature and/or functionality and indication information of changes in the model or model group; and
identification information of the model or model group.

In some embodiments, the information on a change in the model or model group is represented by bit information.

In some embodiments, a change in the model or model group is represented by 1 bit.

In some embodiments, the model or the model in the model group is in a bilateral model structure.

In some embodiments, the model indication information is carried in relevant reporting information.

In some embodiments, the reporting information is CSI reporting information,

and in an IE related to AI/ML in the CSI reporting configuration, indication information reporting that represents model changes is predefined.

In some embodiments, the terminal equipment transmits the model indication information to the network device via uplink signaling.

For example, the model indication information is carried by UCI or an MAC CE or RRC signaling.

In some embodiments, on a physical channel, the model indication information is transmitted via a PUCCH or a PUSCH.

In some embodiments, the indication information includes deactivation request information for an AI/ML feature and/or functionality in an active state and/or request information on fallback to a non-AI/ML mode.

In some embodiments, the deactivation request information includes at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

In some embodiments, the indication information includes activation request information for an AI/ML feature and/or functionality in an inactive state.

In some embodiments, the activation request information includes at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

In some embodiments, the AI/ML feature includes at least one AI/ML functionality.

In some embodiments, the AI/ML feature includes at least one AI/ML feature group.

In some embodiments, the AI/ML feature group includes at least one AI/ML functionality.

In some embodiments, the AI/ML functionality is an AI/ML sub-feature.

In some embodiments, the AI/ML feature includes an AI/ML feature identifier.

In some embodiments, the AI/ML functionality includes an AI/ML functionality identifier, or, the AI/ML sub-feature includes an AI/ML sub-feature identifier.

In another implementation, the information transmission apparatus and the processor 2210 may be configured separately; for example, the information transmission apparatus may be configured as a chip connected to the processor 2210, and the functions of the information transmission apparatus are executed under control of the processor 2210.

As shown in FIG. 22, the terminal equipment 2200 may further include a communication module 2230, an input unit 2240, a display 2250, and a power supply 2260. It should be noted that the terminal equipment 2200 does not necessarily include all the parts shown in FIG. 22, and the above components are not necessary. Furthermore, the terminal equipment 2200 may include parts not shown in FIG. 22, and the related art may be referred to.

As shown in FIG. 22, the processor 2210 is sometimes referred to as a controller or an operational control, which may include a microprocessor or other processor devices and/or logic devices. The processor 2210 receives input and controls operations of components of the terminal equipment 2200.

Wherein, the memory 2220 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 2210 may execute programs stored in the memory 2220, so as to realize information storage or processing, etc. Functions of other parts are similar to those of the related art, which shall not be described herein any further. The parts of the terminal equipment 2200 may be realized by specific hardware, firmware, software, or any combination thereof, without departing from the scope of this disclosure.

It can be seen from the above embodiment that the terminal equipment transmits the indication information related to the AI/ML feature and/or functionality to the network device, so that the network device may timely and accurately an actual performance of the AI/ML feature and/or functionality, and achieve accurate operations of the AI/ML feature and/or functionality, thereby fully utilizing the AI/ML functionalities to improve communication quality, and improving performances of the communication system.

### Embodiment of Eighth Aspect

The embodiments of this disclosure provide a network device, including the information transmission apparatus as described in the embodiment of the sixth aspect.

FIG. 23 is a schematic diagram of a systematic structure of the network device of the embodiments of this disclosure. As shown in FIG. 23, a network device 2300 may include a processor 2310 and a memory 2320, the memory 2320 being coupled to the processor 2310. Wherein, the memory 2320 may store various data, and furthermore, it may store a program 2330 for data processing, and execute the program 2330 under control of the processor 2310.

In one implementation, the functions of the information transmission apparatus may be integrated into the processor 2310.

The processor 2310 may be configured to: receive indication information on an AI/ML feature and/or functionality transmitted by a terminal equipment.

In some embodiments, the indication information includes information an AI/ML feature and/or functionality that the terminal equipment expects to use.

In some embodiments, the processor 2310 may further be configured to executes one of the following steps:
transmitting configuration and/or an indication of the indication information to the terminal equipment;
transmitting configuration and/or indication related to an AI/ML feature and/or functionality of the indication information to the terminal equipment;
transmitting a measurement judgment indication related to the AI/ML feature and/or functionality operation of the indication information to the terminal equipment; and
transmitting at least one of a measurement metric, a condition and a performance threshold related to the AI/ML feature and/or functionality operation of the indication information to the terminal equipment.

In some embodiments, the AI/ML feature and/or functionality operation includes at least one of monitoring, selecting, switching, activating and deactivating the AI/ML feature and/or functionality and making the AI/ML feature and/or functionality fallback to a non-AI/ML mode.

In some embodiments, the indication information includes indication information of the AI/ML feature and/or functionality selected by the terminal equipment.

In some embodiments, the indication information includes at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

In some embodiments, the processor 2310 may further be configured to:

transmitting measurement configuration information and/or reporting configuration information to the terminal equipment.

In some embodiments, the measurement configuration information includes at least one of configuration of a CSI resource configuration or CSI resource set configuration and configuration of a type of RS.

In some embodiments, one configuration in the measurement configuration information and/or the reporting configuration information corresponds to implementation of at least one AI/ML feature and/or functionality.

In some embodiments, the measurement configuration information and/or reporting configuration information include(s) evaluation indication information of the AI/ML feature and/or functionality, or selection indication information of the AI/ML feature and/or functionality.

In some embodiments, the measurement configuration information and/or reporting configuration information is/are configured via an identifier/identifiers of the AI/ML feature and/or functionality.

In some embodiments, the AI/ML feature and/or functionality to which the measurement configuration information and/or the reporting configuration information correspond(s) is/are determined by the network device according to the AI/ML feature and/or functionality supported by the terminal equipment reported by the terminal equipment.

In some embodiments, the measurement configuration information and/or reporting configuration information is/are configured via RRC, or,

at least one measurement configuration and/or reporting configuration is/are activated by an MAC CE after the measurement configuration information and/or reporting configuration information is/are configured via RRC.

In some embodiments, the measurement configuration information and/or reporting configuration information includes evaluation indication information for AI/ML.

In some embodiments, the indication information includes switching request information for the AI/ML feature and/or functionality, or activation request information of an AI/ML feature and/or functionality taken as a switching target.

In some embodiments, the indication information includes at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

In some embodiments, the processor 2310 may further be configured to:

configure evaluation index information for switching the AI/ML feature and/or functionality for the terminal equipment.

In some embodiments, the evaluation index information includes at least one of a measurement index, a measurement threshold, a comparison index, and a comparison threshold.

In some embodiments, the indication information includes at least one of input configuration-related information and output configuration-related information to which the AI/ML feature and/or functionality corresponds.

In some embodiments, the indication information includes model indication information.

In some embodiments, the model indication information includes change information of a model or model group implementing the AI/ML feature and/or functionality.

In some embodiments, the change information of the model or model group includes at least one of the following information:
information on changes in a model or model groups;
identification information of the AI/ML feature and/or functionality and indication information of changes in the model or model group; and
identification information of the model or model group.

In some embodiments, the information on a change in the model or model group is represented by bit information.

In some embodiments, a change in the model or model group is represented by 1 bit.

In some embodiments, the model or the model in the model group is in a bilateral model structure.

In some embodiments, the model indication information is carried in relevant reporting information.

In some embodiments, the reporting information is CSI reporting information,

and in an IE related to AI/ML in the CSI reporting configuration, indication information reporting that represents model changes is predefined.

In some embodiments, the model indication information is transmitted via uplink signaling.

In some embodiments, the model indication information is carried by UCI or an MAC CE or RRC signaling.

In some embodiments, on a physical channel, the model indication information is transmitted via a PUCCH or a PUSCH.

In some embodiments, the indication information includes deactivation request information for an AI/ML feature and/or functionality in an active state and/or request information on fallback to a non-AI/ML mode.

In some embodiments, the deactivation request information includes at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

The indication information includes activation request information for an AI/ML feature and/or functionality in an inactive state.

In some embodiments, the activation request information includes at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

In some embodiments, the AI/ML feature includes at least one AI/ML functionality.

In some embodiments, the AI/ML feature includes at least one AI/ML feature group.

In some embodiments, the AI/ML feature group includes at least one AI/ML functionality.

In some embodiments, the AI/ML functionality is an AI/ML sub-feature.

In some embodiments, the AI/ML feature includes an AI/ML feature identifier.

In some embodiments, the AI/ML functionality includes an AI/ML functionality identifier, or, the AI/ML sub-feature includes an AI/ML sub-feature identifier.

In another implementation, the information transmission apparatus and the processor 2310 may be configured separately; for example, the information transmission apparatus may be configured as a chip connected to the processor 2310, and the functions of the information transmission apparatus are executed under control of the processor 2310.

Furthermore, as shown in FIG. 23, the network device 2300 may include a transceiver 2340, and an antenna 2350, etc. Wherein, functions of the above components are similar to those in the related art, and shall not be described herein any further. It should be noted that the network device 2300 does not necessarily include all the parts shown in FIG. 23. Furthermore, the network device 2300 may include parts not shown in FIG. 23, and the related art may be referred to.

It can be seen from the above embodiment that the network device receives the indication information related to the AI/ML feature and/or functionality from the terminal equipment, so that the network device may timely and accurately an actual performance of the AI/ML feature and/or functionality, and achieve accurate operations of the AI/ML feature and/or functionality, thereby fully utilizing the AI/ML functionalities to improve communication quality, and improving performances of the communication system.

### Embodiment of a Ninth Aspect

The embodiments of this disclosure provide a communication system, including the terminal equipment described in the embodiment the seventh aspect and/or the network device described in the embodiment the eighth aspect.

For example, reference may be made to FIG. 1 for a structure of the communication system.

As shown in FIG. 1, the communication system 100 includes the network device 101 and the terminal equipment 102. The network device 101 may be identical to the network device described in the embodiment the ninth aspect, and the terminal equipment 102 may be identical to the terminal equipment described in the embodiment the eighth aspect, with repeated parts being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 20 may either correspond to software modules of procedures of a computer program, or correspond to hardware modules. Such software modules may respectively correspond to the steps shown in FIG. 5. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 12 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 12 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to the implementations including the above embodiments, following supplements are further disclosed.

1. An information transmission method, the method including:

transmitting, by a terminal equipment, indication information on an AI/ML feature and/or functionality to a network device.

2. The method according to supplement 1, wherein,

the indication information includes information an AI/ML feature and/or functionality that the terminal equipment expects to use.

3. The method according to supplement 1 or 2, wherein,
the terminal equipment transmits the indication information to the network device in one of the following cases that:
the network device transmits configuration and/or an indication of the indication information to the terminal equipment;
the network device transmits configuration and/or indication related to an AI/ML feature and/or functionality of the indication information to the terminal equipment;
the network device transmits a measurement judgment indication related to the AI/ML feature and/or functionality operation of the indication information to the terminal equipment; and
the network device transmits at least one of a measurement metric, a condition and a performance threshold related to the AI/ML feature and/or functionality operation of the indication information to the terminal equipment.

4. The method according to supplement 3, wherein,

the AI/ML feature and/or functionality operation includes at least one of monitoring, selecting, switching, activating and deactivating the AI/ML feature and/or functionality and making the AI/ML feature and/or functionality fallback to a non-AI/ML mode.

5. The method according to any one of supplements 1-4, wherein,

the indication information includes indication information of the AI/ML feature and/or functionality selected by the terminal equipment.

6. The method according to supplement 5, wherein,
the indication information includes at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

7. The method according to any one of supplements 1-6, wherein the method further includes:

receiving, by the terminal equipment, the measurement configuration information and/or reporting configuration information transmitted by the network device.

8. The method according to supplement 7, wherein,

the measurement configuration information includes at least one of configuration of a CSI resource configuration or CSI resource set configuration and configuration of a type of RS.

9. The method according to supplement 7 or 8, wherein,

one configuration in the measurement configuration information and/or the reporting configuration information corresponds to implementation of at least one AI/ML feature and/or functionality.

10. The method according to any one of supplements 7-9, wherein,

the measurement configuration information and/or reporting configuration information include(s) evaluation indication information of the AI/ML feature and/or functionality, or selection indication information of the AI/ML feature and/or functionality.

11. The method according to any one of supplements 7-10, wherein,

the measurement configuration information and/or reporting configuration information is/are configured via an identifier/identifiers of the AI/ML feature and/or functionality.

12. The method according to any one of supplements 7-11, wherein,

the AI/ML feature and/or functionality to which the measurement configuration information and/or the reporting configuration information correspond(s) is/are determined by the network device according to the AI/ML feature and/or functionality supported by the terminal equipment reported by the terminal equipment.

13. The method according to any one of supplements 7-12, wherein,
the measurement configuration information and/or reporting configuration information is/are configured via RRC, or,
at least one measurement configuration and/or reporting configuration is/are activated by an MAC CE after the measurement configuration information and/or reporting configuration information is/are configured via RRC.

14. The method according to any one of supplements 7-13, wherein,

the measurement configuration information and/or reporting configuration information includes evaluation indication information for AI/ML.

15. The method according to any one of supplements 1-14, wherein,

the indication information includes switching request information for the AI/ML feature and/or functionality, or activation request information of an AI/ML feature and/or functionality taken as a switching target.

16. The method according to supplement 15, wherein,
the indication information includes at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

17. The method according to supplement 15 or 16, wherein the method further includes:

determining by the terminal equipment whether to switch the AI/ML feature and/or functionality according to evaluation index information for switching the AI/ML feature and/or functionality configured by the network side.

18. The method according to supplement 17, wherein,

the evaluation index information includes at least one of a measurement index, a measurement threshold, a comparison index, and a comparison threshold.

19. The method according to any one of supplements 1-18, wherein,

the indication information includes at least one of input configuration-related information and output configuration-related information to which the AI/ML feature and/or functionality corresponds.

20. The method according to any one of supplements 1-19, wherein,

the indication information includes model indication information.

21. The method according to supplement 20, wherein,

the model indication information includes change information of a model or model group implementing the AI/ML feature and/or functionality.

22. The method according to supplement 21, wherein,
the change information of the model or model group includes at least one of the following information:
information on changes in a model or model groups;
identification information of the AI/ML feature and/or functionality and indication information of changes in the model or model group; and
identification information of the model or model group.

23. The method according to supplement 22, wherein,

the information on a change in the model or model group is represented by bit information.

24. The method according to supplement 23, wherein,

a change in the model or model group is represented by 1 bit.

25. The method according to supplement 22, wherein,

the model or the model in the model group is in a bilateral model structure.

26. The method according to any one of supplements 20-25, wherein,

the model indication information is carried in relevant reporting information.

27. The method according to supplement 26, wherein,
the reporting information is CSI reporting information,
and in an IE related to AI/ML in the CSI reporting configuration, indication information reporting that represents model changes is predefined.

28. The method according to any one of supplements 20-25, wherein,

the terminal equipment transmits the model indication information to the network device via uplink signaling.

29. The method according to supplement 28, wherein,

the model indication information is carried by UCI or an MAC CE or RRC signaling.

30. The method according to supplement 28 or 29, wherein,

on a physical channel, the model indication information is transmitted via a PUCCH or a PUSCH.

31. The method according to any one of supplements 1-30, wherein,

the indication information includes deactivation request information for an AI/ML feature and/or functionality in an active state and/or request information on fallback to a non-AI/ML mode.

32. The method according to supplement 31, wherein,
the deactivation request information includes at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

33. The method according to any one of supplements 1-32, wherein,

the indication information includes activation request information for an AI/ML feature and/or functionality in an inactive state.

34. The method according to supplement 33, wherein,
the activation request information includes at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

35. The method according to any one of supplements 1-34, wherein,

the AI/ML feature includes at least one AI/ML functionality.

36. The method according to any one of supplements 1-35, wherein,

the AI/ML feature includes at least one AI/ML feature group.

37. The method according to supplement 36, wherein,

the AI/ML feature group includes at least one AI/ML functionality.

38. The method according to any one of supplements 1-37, wherein,

the AI/ML functionality is an AI/ML sub-feature.

39. The method according to any one of supplements 1-38, wherein,

the AI/ML feature includes an AI/ML feature identifier.

40. The method according to any one of supplements 1-39, wherein,

the AI/ML functionality includes an AI/ML functionality identifier, or, the AI/ML sub-feature includes an AI/ML sub-feature identifier.

41. An information transmission method, the method including:

receiving, by a network device, indication information on an AI/ML feature and/or functionality transmitted by a terminal equipment.

42. The method according to supplement 41, wherein,

the indication information includes information an AI/ML feature and/or functionality that the terminal equipment expects to use.

43. The method according to supplement 41 or 42, wherein the method further includes one of the following steps:
transmitting configuration and/or an indication of the indication information by the network device to the terminal equipment;
transmitting configuration and/or indication related to an AI/ML feature and/or functionality of the indication information by the network device to the terminal equipment;
transmitting a measurement judgment indication related to the AI/ML feature and/or functionality operation of the indication information by the network device to the terminal equipment; and
transmitting at least one of a measurement metric, a condition and a performance threshold related to the AI/ML feature and/or functionality operation of the indication information by the network device to the terminal equipment.

44. The method according to supplement 43, wherein,

the AI/ML feature and/or functionality operation includes at least one of monitoring, selecting, switching, activating and deactivating the AI/ML feature and/or functionality and making the AI/ML feature and/or functionality fallback to a non-AI/ML mode.

45. The method according to any one of supplements 41-44, wherein,

the indication information includes indication information of the AI/ML feature and/or functionality selected by the terminal equipment.

46. The method according to supplement 45, wherein,
the indication information includes at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

47. The method according to any one of supplements 41-46, wherein the method further includes:

transmitting measurement configuration information and/or reporting configuration information by the network device to the terminal equipment.

48. The method according to supplement 47, wherein,

the measurement configuration information includes at least one of configuration of a CSI resource configuration or CSI resource set configuration and configuration of a type of RS.

49. The method according to supplement 47 or 48, wherein,

one configuration in the measurement configuration information and/or the reporting configuration information corresponds to implementation of at least one AI/ML feature and/or functionality.

50. The method according to any one of supplements 47-49, wherein,

the measurement configuration information and/or reporting configuration information include(s) evaluation indication information of the AI/ML feature and/or functionality, or selection indication information of the AI/ML feature and/or functionality.

51. The method according to any one of supplements 47-50, wherein,

the measurement configuration information and/or reporting configuration information is/are configured via an identifier/identifiers of the AI/ML feature and/or functionality.

52. The method according to any one of supplements 47-51, wherein,

the AI/ML feature and/or functionality to which the measurement configuration information and/or the reporting configuration information correspond(s) is/are determined by the network device according to the AI/ML feature and/or functionality supported by the terminal equipment reported by the terminal equipment.

53. The method according to any one of supplements 47-52, wherein,
the measurement configuration information and/or reporting configuration information is/are configured via RRC, or,
at least one measurement configuration and/or reporting configuration is/are activated by an MAC CE after the measurement configuration information and/or reporting configuration information is/are configured via RRC.

54. The method according to any one of supplements 47-53, wherein,

the measurement configuration information and/or reporting configuration information includes evaluation indication information for AI/ML.

55. The method according to any one of supplements 47-54, wherein,

the indication information includes switching request information for the AI/ML feature and/or functionality, or activation request information of an AI/ML feature and/or functionality taken as a switching target.

56. The method according to supplement 55, wherein,
the indication information includes at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

57. The method according to supplement 55 or 56, wherein the method further includes:

configuring evaluation index information for switching the AI/ML feature and/or functionality for the terminal equipment by the network device.

58. The method according to supplement 57, wherein,

the evaluation index information includes at least one of a measurement index, a measurement threshold, a comparison index, and a comparison threshold.

59. The method according to any one of supplements 41-58, wherein,

the indication information includes at least one of input configuration-related information and output configuration-related information to which the AI/ML feature and/or functionality corresponds.

60. The method according to any one of supplements 41-59, wherein,

the indication information includes model indication information.

61. The method according to supplement 60, wherein,

the model indication information includes change information of a model or model group implementing the AI/ML feature and/or functionality.

62. The method according to supplement 61, wherein,
the change information of the model or model group includes at least one of the following information:
information on changes in a model or model groups;
identification information of the AI/ML feature and/or functionality and indication information of changes in the model or model group; and
identification information of the model or model group.

63. The method according to supplement 62, wherein,

the information on a change in the model or model group is represented by bit information.

64. The method according to supplement 63, wherein,

a change in the model or model group is represented by 1 bit.

65. The method according to supplement 62, wherein,

the model or the model in the model group is in a bilateral model structure.

66. The method according to any one of supplements 60-65, wherein,

the model indication information is carried in relevant reporting information.

67. The method according to supplement 66, wherein,
the reporting information is CSI reporting information,
and in an IE related to AI/ML in the CSI reporting configuration, indication information reporting that represents model changes is predefined.

68. The method according to any one of supplements 60-65, wherein,

the model indication information is transmitted via uplink signaling.

69. The method according to supplement 68, wherein,

the model indication information is carried by UCI or an MAC CE or RRC signaling.

70. The method according to supplement 68 or 69, wherein,

on a physical channel, the model indication information is transmitted via a PUCCH or a PUSCH.

71. The method according to any one of supplements 41-70, wherein,

the indication information includes deactivation request information for an AI/ML feature and/or functionality in an active state and/or request information on fallback to a non-AI/ML mode.

72. The method according to supplement 71, wherein,
the deactivation request information includes at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

73. The method according to any one of supplements 41-72, wherein,

the indication information includes activation request information for an AI/ML feature and/or functionality in an inactive state.

74. The method according to supplement 73, wherein,

the activation request information includes at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

75. The method according to any one of supplements 41-74, wherein,

the AI/ML feature includes at least one AI/ML functionality.

76. The method according to any one of supplements 41-75, wherein,

the AI/ML feature includes at least one AI/ML feature group.

77. The method according to supplement 76, wherein,

the AI/ML feature group includes at least one AI/ML functionality.

78. The method according to any one of supplements 41-77, wherein,

the AI/ML functionality is an AI/ML sub-feature.

79. The method according to any one of supplements 41-78, wherein,

the AI/ML feature includes an AI/ML feature identifier.

80. The method according to any one of supplements 41-79, wherein,

the AI/ML functionality includes an AI/ML functionality identifier, or, the AI/ML sub-feature includes an AI/ML sub-feature identifier.

81. An information transmission method, the method including:

transmitting, by a terminal equipment, indication information of an AI/ML feature and/or functionality selected by the terminal equipment to a network device.

82. An information transmission method, the method including:

transmitting switching request information for an AI/ML feature and/or functionality, or activation request information of an AI/ML feature and/or functionality taken as a switching target, by a terminal equipment to a network device.

83. An information transmission method, the method including:

transmitting model indication information related to an AI/ML feature and/or functionality by a terminal equipment to a network device.

84. An information transmission method, the method including:

transmitting deactivation request information for an AI/ML feature and/or functionality in an active state and/or request information on fallback to a non-AI/ML mode by a terminal equipment to a network device.

85. An information transmission method, the method including:

transmitting activation request information for an AI/ML feature and/or functionality in an inactive state by a terminal equipment to a network device.

86. An information transmission method, the method including one of the following steps:
transmitting configuration and/or an indication of the indication information by a network device to a terminal equipment;
transmitting configuration and/or indication related to an AI/ML feature and/or functionality of the indication information by the network device to the terminal equipment;
transmitting measurement judgment indications related to the AI/ML feature and/or functionality operation of the indication information by the network device to the terminal equipment; and
transmitting at least one of a measurement metric, a condition and a performance threshold related to the AI/ML feature and/or functionality operation of the indication information by the network device to the terminal equipment.

87. A method for verifying performances of a model, the method including:
receiving a test vector set and reporting configuration by a terminal equipment from a network device; and
inputting test vectors in the test vector set to a model, and transmitting output of the model to the network device according to the reporting configuration, by the terminal equipment.

88. The method according to supplement 87, wherein,

the test vector set is carried by RRC.

89. The method according to supplement 87 or 88, wherein,
a correspondence between the test vectors in the test vector set and the model is indicated by indication information transmitted by the network device, or
the test vector set includes an identifier corresponding to the model.

90. A method for verifying performances of a model, the method including:
transmitting a test vector set by a network device to a terminal equipment; and
receiving, by the network device, output of the model transmitted by the terminal equipment.

91. The method according to supplement 90, wherein,

the network device transmits the test vector set to the terminal equipment via an RRC message.

92. The method according to supplement 90 or 91, wherein,
a correspondence between the test vectors in the test vector set and the model is indicated by indication information transmitted by the network device, or
the test vector set includes an identifier corresponding to the model.

93. The method according to any one of supplements 90-92, wherein the method further includes:

informing the terminal equipment of a use of the test vector set via a specific RRC message or other bound configurations, and transmitting relevant reporting configurations, by the network device.

94. A terminal equipment, including a memory and a processor, the memory storing a computer program, and the processor being configured to execute the computer program to carry out the method as described in any one of supplements 1-40, 81-85 and 87-89.

95. A network device, including a memory and a processor, the memory storing a computer program, and the processor being configured to execute the computer program to carry out the method as described in any one of supplements 41-80, 86 and 90-93.

96. A communication system, including the terminal equipment as described in supplement 94 and/or the network device as described in supplement 95.

97. A method for identifying an AI/ML model, the method including:

indicating whether an AI/ML model has been tested via a part of bit information or numerical information in a model identifier of the AI/ML model.

98. The method according to supplement 97, wherein,

the model identifier is a global identifier.

99. The method according to supplement 97 or 98, wherein,

whether the AI/ML model has been tested is indicated by a bit or a number in a bit string or number string of the model identifier.

100. A method for identifying an AI/ML model, the method including:

for an AI/ML model that does not have a global identifier, after testing and verification satisfy preset conditions, providing a global identifier of the AI/ML model by the network side.

101. The method according to supplement 100, wherein,

after testing and verification satisfy preset conditions, the network side provides a global identifier of the AI/ML model in a process of model registration or model identification.

102. The method according to supplement 100 or 101, wherein,

after testing and verification satisfy preset conditions, the network device or terminal equipment transmits relevant model information to a network element responsible for managing global model identifiers, and obtains a global identifier of the AI/ML model from the network element.

103. A method for identifying an AI/ML model, the method including:

for an AI/ML model that is not registered on a network, indicating whether the AI/ML model has been tested by an initial model identifier of the AI/ML model.

104. The method according to any one of supplements 97-103, wherein,

the test includes at least one of interoperability test, RAN4 test, and network access test.

1. An information transmission apparatus, configured in a terminal equipment, the apparatus comprising:
a transmitter configured to transmit indication information on an AI/ML feature and/or functionality to a network device.

2. The apparatus according to claim 1, wherein,
the indication information comprises information on an AI/ML feature and/or functionality that the terminal equipment expects to use.

3. The apparatus according to claim 1, wherein,
the transmitter transmits the indication information to the network device in one of the following cases that:
the network device transmits configuration and/or an indication of the indication information to the terminal equipment;
the network device transmits configuration and/or indication related to an AI/ML feature and/or functionality of the indication information to the terminal equipment;
the network device transmits a measurement judgment indication related to the AI/ML feature and/or functionality operation of the indication information to the terminal equipment; and
the network device transmits at least one of a measurement metric, a condition and a performance threshold related to the AI/ML feature and/or functionality operation of the indication information to the terminal equipment.

4. The apparatus according to claim 3, wherein,
the AI/ML feature and/or functionality operation comprises at least one of monitoring, selecting, switching, activating and deactivating the AI/ML feature and/or functionality and making the AI/ML feature and/or functionality fallback to a non-AI/ML mode.

5. The apparatus according to claim 1, wherein,
the indication information comprises indication information on an AI/ML feature and/or functionality selected by the terminal equipment.

6. The apparatus according to claim 5, wherein,
the indication information comprises at least one piece of the following information:
identification information of the AI/ML feature and/or functionality selected by the terminal equipment;
configuration indication information corresponding to the selected AI/ML feature and/or functionality for the measurement configuration information and/or reporting configuration information transmitted by the network device;
information on applicability for the selected AI/ML feature and/or functionality; and
quality information of a signal used in judging the selected AI/ML feature and/or functionality.

7. The apparatus according to claim 1, the apparatus further comprising:
a first receiver configured to receive the measurement configuration information and/or reporting configuration information transmitted by the network device.

8. The apparatus according to claim 7, wherein,
the measurement configuration information comprises at least one of configuration of a CSI resource configuration or CSI resource set configuration and configuration of a type of RS.

9. The apparatus according to claim 1, wherein,
the indication information comprises switching request information for the AI/ML feature and/or functionality, or activation request information of an AI/ML feature and/or functionality taken as a switching target.

10. The apparatus according to claim 9, wherein,
the indication information comprises at least one piece of the following information:
identification information of the AI/ML feature and/or functionality taken as a switching target;
configuration indication information to which the AI/ML feature and/or functionality taken as a switching target correspond(s);
information on applicability for the selected AI/ML feature and/or functionality; and
quality information of a signal used in judging a switching AI/ML feature and/or functionality.

11. The apparatus according to claim 1, wherein,
the indication information comprises model indication information.

12. The apparatus according to claim 11, wherein,
the model indication information comprises change information of a model or model group that implements the AI/ML feature and/or functionality.

13. The apparatus according to claim 12, wherein,
the change information of the model or model group comprises at least one piece of the following information:
information on changes in the model or model group;
identification information of the AI/ML feature and/or functionality and indication information of changes in the model or model group; and
identification information of the model or model group.

14. The apparatus according to claim 11, wherein,
the model indication information is carried in relevant reporting information.

15. The apparatus according to claim 11, wherein,
the transmitter transmits the model indication information to the network device via uplink signaling.

16. The apparatus according to claim 11, wherein,
the indication information comprises deactivation request information for an AI/ML feature and/or functionality in an active state and/or request information on fallback to a non-AI/ML mode.

17. The apparatus according to claim 16, wherein,
the deactivation request information comprises at least one piece of the following information:
identification information of the AI/ML feature and/or functionality in the active state;
indication information on deactivation;
information on applicability for a deactivated AI/ML feature and/or functionality;
quality information of a signal used in judging a deactivated AI/ML feature and/or functionality;
identification information of reporting configuration; and
identification information of resource or resource set configuration.

18. The apparatus according to claim 1, wherein,
the indication information comprises activation request information for an AI/ML feature and/or functionality in an inactive state.

19. The apparatus according to claim 18, wherein,
the activation request information comprises at least one piece of the following information:
identification information of the AI/ML feature and/or functionality in an inactive state;
request information or indication information of an active AI/ML;
information on applicability for an active AI/ML feature and/or functionality;
quality information of a signal used in judging an active AI/ML feature and/or functionality;
identification information of reporting configuration; and
identification information of resource or resource set configuration.

20. An information transmission apparatus, configured in a network device, the apparatus comprising:
a second receiver configured to receive indication information on an AI/ML feature and/or functionality transmitted by a terminal equipment.
